(19) United States
(12) Patent Application Publication
(10) Pub. No.: US 2009/0024864 A1
(43) Pub. Date: Jan. 22, 2009

(54) AUDIO PROCESSOR HAVING DYNAMIC AUTOMATIC CONTROL FUNCTION OF OPERATING FREQUENCY

(75) Inventor: Hiroki SUGIMOTO, Kawasaki (JP)

Correspondence Address: YOUNG & THOMPSON, 209 Madison Street, Suite 500, ALEXANDRIA, VA, 22314, US

(73) Assignee: NEC ELECTRONICS CORPORATION, KAWASAKI (JP)

(21) Appl. No.: 12/170,521

(22) Filed: Jul. 10, 2008

(30) Foreign Application Priority Data
Jul. 19, 2007 (JP) 2007/188182

(51) Int. Cl. G06F 1/06; G06F 12/00

(52) U.S. Cl. 713/501; 711/154; 711/E12.001

(57) ABSTRACT

A data processing system includes a processor for writing data processed based on a clock signal in a buffer for storing and outputting written data, and the processor changes a frequency of the clock signal supplied to the processor in accordance with an amount of data stored in the buffer.

### BACKGROUND OF THE INVENTION

1. Field of the Invention

The present invention relates to a data processing system, and more specifically, a data processing system including a processor for decoding encoded data.

2. Description of Related Art

In recent years, attention has been placed on technologies for delivering encoded (e.g., compressed) moving picture data or music data as stream data, which is decoded so that the moving picture or the music can be reproduced. When the compressed moving picture data or music data as the stream data is decoded by a processor such as a digital signal processor, throughput in a decoding process performed by the processor varies. For example, the number of clocks necessary for the processor to decode a block in the music data corresponding to a silence portion is smaller than the number of clocks necessary for the processor to decode a block in the music data corresponding to a melody-playing portion. Therefore, in order to support such a variation of throughput of a processor, a clock frequency of a clock supplied to the processor is set to a certain value determined by estimating a maximum throughput of the processor in a conventional method.

Note that, as a related art, Japanese Patent Application Laid-open No. 2003-280760 describes a technology concerning a decoding method of data (MPEG data) compressed using Moving Picture Experts Group (MPEG) as one of data compression formats, in which a clock frequency of a received clock signal is adjusted based on a data length of a frame to be decoded when a Central Processing Unit (CPU) decodes the MPEG data. In addition, Japanese Patent Application Laid-open No. 2000-059232 describes a technology in which a plurality of processors are used for the decoding process.

The inventor has found that the above-mentioned conventional technologies have the following problem. The processor decodes individual blocks of the stream data so as to write them in an outputting buffer sequentially based on a clock having a clock frequency value that is determined by estimating a maximum throughput of the processor. However, the clock frequency of the clock supplied to the processor is not the value determined by considering a write speed when the processor writes data in the outputting buffer and a speed necessary for the buffer to output the data written by the processor for external use. Therefore, if an amount of write data exceeds an amount of read data, a storage area of the outputting buffer will be soon filled up with the data written by the processor. In this case, the processor cannot write data in the buffer, so it is not necessary to perform the decoding process until a free storage area is generated in the outputting buffer. However, the processor continues to receive the clock having the clock frequency estimating the maximum throughput even in the period while the processor does not perform the decoding process. In this case, the process or consumes wasteful power. In addition, although there is a method of decreasing clock frequency of the clock to be supplied to the processor during the period in which the processor does not perform the decoding process (i.e., a method of utilizing a low power consumption mode), the processor will still consume wasteful power as long as the processor continues to receive the clock.

### SUMMARY

A data processing system according to the present invention includes a buffer for storing write data and for outputting the write data that is stored, and a processor for outputting data processed based on a clock signal as the write data to the buffer and for changing a frequency of the clock signal in accordance with a data amount of the write data stored in the buffer.

According to this configuration, it is possible to realize a control for the processor, which determines that an amount of input data of the buffer is excessive if an amount of stored data in the buffer is larger than a predetermined reference value so as to reduce a frequency of the clock signal received by the processor, and determines that an amount of input data of the buffer is insufficient if an amount of stored data in the buffer is smaller than the predetermined reference value so as to increase a frequency of the clock signal received by the processor. Thus, the processor can perform a control of changing a frequency of the clock signal in accordance with an amount of data in the buffer.

The present invention produces an effect that power consumption of the processor can be reduced because a frequency of the clock signal received by the processor can be changed in accordance with an amount of data stored in the buffer.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 shows a structure of a system according to an embodiment of the present invention,

FIG. 2 shows an example of an operation of the system according to the embodiment of the present invention; and

FIG. 3 shows a concrete example of a state of a buffer according to the embodiment of the present invention.

### DETAILED DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes.

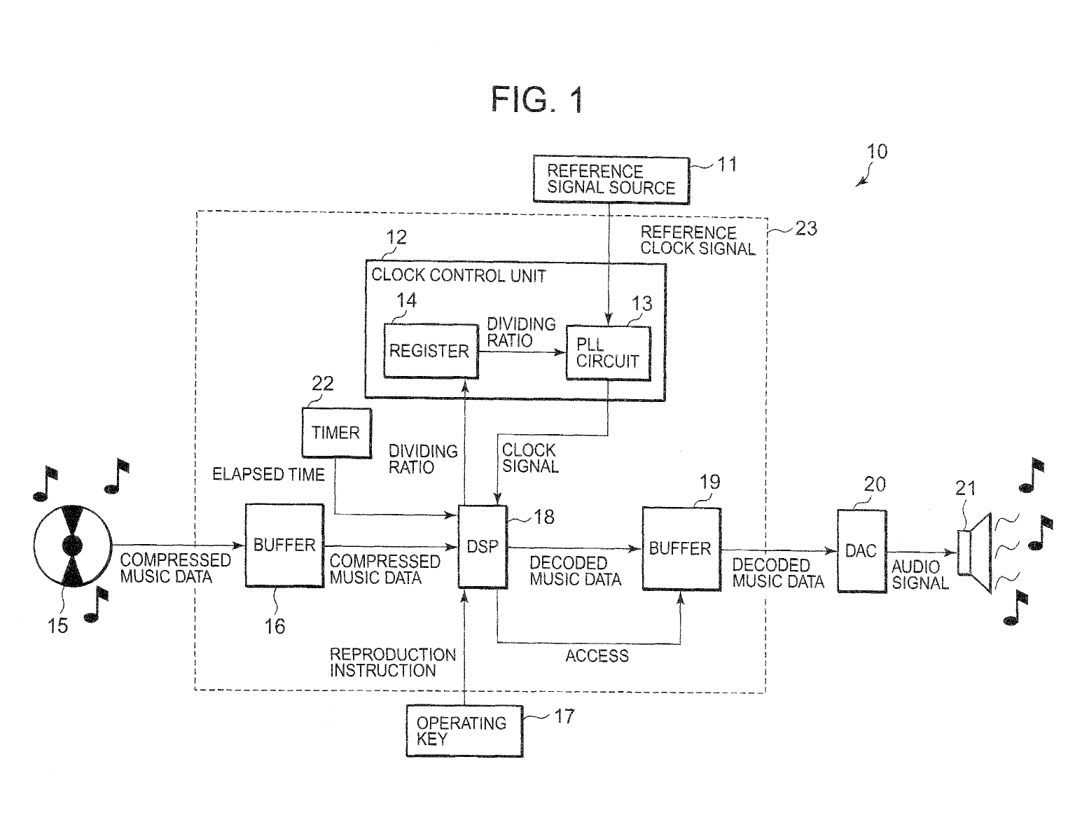

Hereinafter, a preferred embodiment of the present invention will be described with reference to the attached drawings. Note that, although data to be dealt with is music data in the embodiment of the present invention described below, the data to be dealt with is not limited to the music data. For example, it is possible to use moving picture data for embodying the present invention. An example of a structure of a system 10 that is used for embodying the present invention is shown in FIG. 1. For example, the system 10 is included in a circuit for reproducing sound mounted on a mobile phone. The system 10 includes a reference signal source 11, a clock control unit 12, a buffer 16 for receiving data from a medium 15, an operating key 17, a digital signal processor (DSP) 18, a buffer 19 for supplying decoded data to a speaker 21 via a DAC 20, and a timer 22.

The reference signal source 11 supplies a reference clock signal to be a basis for generating a clock signal to a PLL circuit 13 included in the clock control unit 12. The PLL circuit 13 includes internally a phase comparator, a loop filter, a voltage controlled oscillator, and a frequency divider, and it generates a clock signal having the same phase as the reference clock signal and a multiplied frequency of the reference clock signal. A register 14 included in the clock control unit 12 stores a value to be supplied to the frequency divider included in the PLL circuit 13, namely a value of a dividing ratio. The frequency divider included in the PLL circuit 13 receives a value of the register 14 and changes the dividing ratio. Responding to a result thereof, the PLL circuit 13 changes a frequency of the clock signal to be supplied to the DSP 18. The buffer 16 receives compressed data from the medium 15 such as an SD card or a NAND Flash memory and keeps the data so as to output it to the DSP 18. The data to be written in the buffer 16 from the medium 15 is, for example, music data compressed by the format of MP3 or the like. The operating key 17 is used for instructing the DSP 18 to start reading the compressed data stored in the buffer 16, decoding the data and delivering the decoded data to the buffer 19, i.e., an instruction to reproduce music data, for example. For example, an operating key of a mobile phone equipped with the system 10 can be the operating key 17. The DSP 18 is a processor for performing high speed processing of a specific signal. The DSP 18 receives the reproduction instruction from the operating key 17, reads the compressed music data stored in the buffer 16, decodes the data, and writes the data in the buffer 19. The DSP 18 also instructs the buffer 19 to output the data stored in the buffer 19 to the DAC 20. In addition, the DSP 18 makes access to the buffer 19 at a predetermined timing so as to check an amount of data stored in the buffer 19. The DSP 18 determines the dividing ratio of the frequency divider included in the PLL circuit 13 based on a result of the checking, so as to send the determined dividing ratio to the register 14 included in the PLL circuit 13. The buffer 19 keeps the music data decoded by the DSP 18 and delivers it to the DA converter 20 (DAC). For example, the buffer 19 continues to output the data stored from a time point when the data decoded by the DSP 18 is stored in a half of storage capacity to the DAC 20 at a constant ratio. An instruction to start delivering the data for the buffer 19 is performed by the DSP 18 that transmits a control signal to the buffer 19. The DAC 20 converts the music data delivered from the buffer 19 into an analog audio signal, which is supplied to the speaker 21. The speaker 21 receives the audio signal and performs amplification and the like of the signal so as to output it externally. The timer 22 counts elapsed time. The DSP 18 uses a value counted by the timer 22 as a trigger for reading data from the buffer 16 and performs operations of decoding the read data and writing the decoded data in the buffer 19. Here, a domain 23 within the system 10 can be made a single chip LSI for reproducing sounds.

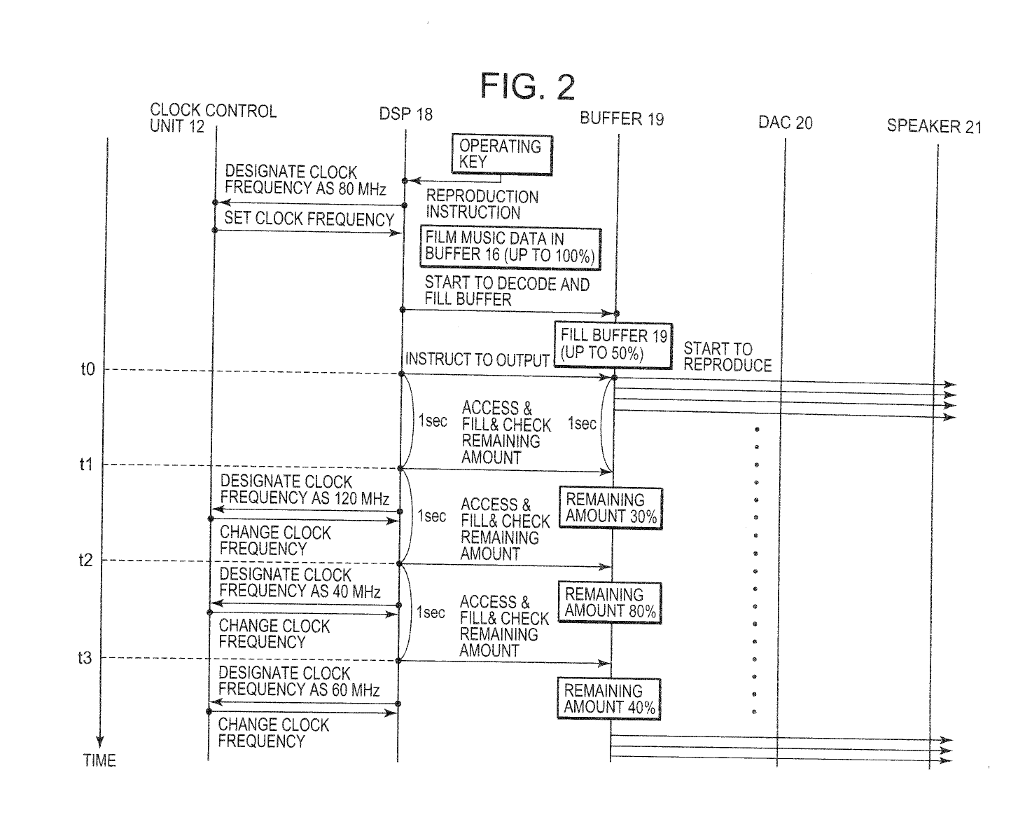

FIG. 2 is a diagram showing schematically an operation of the system 10 shown in FIG. 1, and it shows an example of operations performed by the clock control unit 12, the DSP 18, the buffer 19, the DAC 20 and the speaker 21. The operations will be described in detail with reference to FIGS. 1 and 2.

First, the DSP 18 receives the reproduction instruction via the operating key 17. Based on the received reproduction instruction, the DSP 18 writes the dividing ratio in the register 14 included in the clock control unit 12 and determines a clock frequency of the clock signal that is delivered from the PLL circuit 13 included in the clock control unit 12. For example, the DSP 18 sets the dividing ratio so that the PLL circuit 13 delivers the clock signal having a clock frequency of 80 MHz. The PLL circuit 13 included in the clock control unit 12 determines the dividing ratio of the frequency divider included internally in the PLL circuit 13 based on the dividing ratio stored in the register 14, and it delivers the clock signal having a clock frequency corresponding to 80 MHz designated by the DSP 18. Thus, the clock frequency of the clock signal delivered from the PLL circuit 13 varies based on the dividing ratio set by the DSP 18 for the register 14.

Next, the buffer 16 is filled with the compressed music data from the medium 15. The buffer 16 temporarily stores as much music data of the medium 15 as possible because a storage capacity in a mobile phone is small. In addition, the buffer 16 can be a First In First Out (FIFO) buffer, in which data stored first is output and consumed first. When the buffer 16 is filled up with the compressed data from the medium 15, the DSP 18 reads the compressed music data from the buffer 16 so as to start decoding the data as well as to start delivering the decoded music data to the buffer 19. When the DSP 18 reads the music data sequentially from the buffer 16, the buffer 16 consumes the stored music data. The consumption of the music data generates a free space in the storage area of the buffer 16. New music data is supplied from the medium 15 to the free space in the storage area generated by the consumption of the stored music data.

The DSP 18 writes the decoded data in the buffer 19 sequentially so as to fill the buffer 19. Here, the DSP 18 fills the buffer 19 with the decoded music data while it checks a remaining amount of the music data stored in the buffer 19. Then, when 50% of the storage capacity of the buffer 19 is filled with the music data decoded by the DSP 18 at a time point t0, the DSP 18 instructs the buffer 19 to deliver the music data stored in the buffer 19 to the DAC 20. The music data delivered from the buffer 19 is converted by the DAC 20 into an analog audio signal, which is output externally through the speaker after a process such as amplification so that reproduction of the music data is started. The DSP 18 temporarily halts the writing of the decoded music data in the buffer 19 at the time point t0. After that, the DSP 18 performs its operation by using a value counted by the timer 22 as a trigger.

After the time point t0, the DSP 18 makes access to the buffer 19 regularly based on a value counted by the timer 22. For example, the DSP 18 makes the access every one second based on the value counted by the timer 22. For specific description below, the DSP 18 makes access to the buffer 19 everyone second. Here, the DSP 18 performs the following process in each access.

The DSP 18 uses the value counted by the timer 22 as a trigger so as to make access to the buffer 19 at a time point t1 that is one second after the time point t0 and to check an amount of the music data stored in the buffer 19. Next, the DSP 18 checks a difference between a maximum amount of data that can be stored in the buffer 19 and the amount of the music data stored in the buffer 19 at the time point t1, i.e., the remaining storage capacity of the buffer 19. Then, the DSP 18 determines, based on the remaining storage capacity, whether it is possible or not to write the decoded music data in the buffer 19. More specifically, the remaining storage capacity is compared with an amount of data to be written in the buffer 19 by the DSP 18. If the remaining storage capacity is larger than the amount of data to be written in the buffer 19 by the DSP 18, the DSP 18 determines that it is possible to write the decoded music data in the buffer 19. If the DSP 18 has made such a determination, the DSP 18 makes access to the buffer 16, sequentially reads blocks of the music data stored in the buffer 16, decodes the read data, and writes the decoded data in the buffer 19 one after another. In other words, after the DSP 18 temporarily halts the writing of the data in the buffer 19 at the time point t0, the DSP 18 writes the data in the buffer 19 by using the value counted by the timer 22 as a trigger when it makes access to the buffer 19. Here, the amount of the music data to be written in the buffer 19 by the DSP 18 at every access depends on a sampling rate of the music data stored in the medium 15, the clock frequency of the clock signal to be supplied to the DSP 18 from the PLL circuit 13, and the like. In addition, the DSP 18 calculates a sum of the amount of the data stored in the buffer 19 at the time point t1 and the amount of the data written in the buffer 19 after the access at the time point t1, so as to check whether or not the sum is larger than a predetermined reference value. For example, the predetermined reference value is set to 50% of the maximum amount of data that can be stored in the buffer 19. If the sum recognized by the DSP 18 corresponds to 30% of the maximum amount of data that can be stored in the buffer 19, the DSP 18 determines that a clock frequency of the clock signal supplied from the PLL circuit 13 is low and performs control of increasing the clock frequency. For example, the DSP 18 performs control of increasing the clock frequency from 80 MHz to 120 MHz. More specifically, the DSP 18 writes in the register 14 a value for changing the dividing ratio of the frequency divider included in the PLL circuit 13, so as to increase a value of the dividing ratio of the frequency divider included in the PLL circuit 13.

Next, the PLL circuit 13 increases the dividing ratio of the frequency divider based on the value that has been written in the register 14. If the dividing ratio increases, a higher frequency signal can be extracted from the voltage controlled oscillator included in the PLL circuit 13. The PLL circuit 13 delivers the clock signal with the changed clock frequency to the DSP 18.

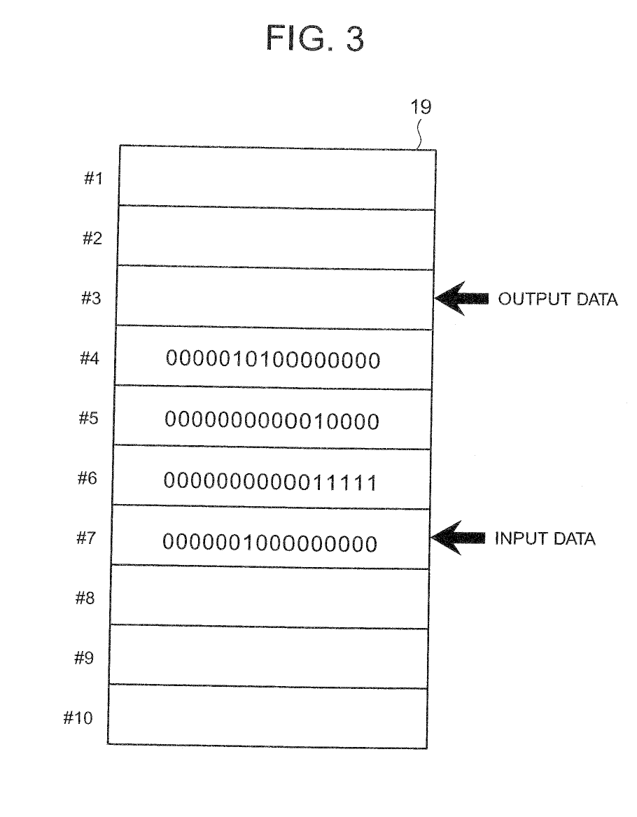

Here, a method for the DSP 18 to check an amount or the like of the data stored in the buffer 19 will be described with reference to FIG. 3. For simple description, it is supposed that the buffer 19 has storage areas designated by addresses of one to ten, and that each of the storage areas can store 16-bit data. In addition, it is supposed that the buffer 19 is a First In First Out (FIFO) buffer, in which input data is output and consumed in turn. Further, it is supposed that the DSP 18 writes the 16-bit data to fill one storage area of the buffer 19 by one writing operation after making access to the buffer 19. It is supposed that an address indicating a storage position of the last data written in the buffer 19 at one time point when the DSP 18 has made access to the buffer 19 is an address of seven, and that an address indicating a storage position of the last data output from the buffer 19 to the DAC 20 to be consumed is an address of three. The DSP 18 obtains various values including an amount of data stored in the buffer 19 from a difference between the above-mentioned two addresses. At one time point when the buffer 19 is in the state shown in FIG. 3, the difference between the two addresses is four. Therefore, an amount of data stored in the buffer 19 is 4 multiplied by 16 bits. Then, a remaining storage capacity of the buffer 19 is 6 multiplied by 16 bits. Since an amount of data written in the buffer 19 by the DSP 18 at one writing operation is one multiplied by 16 bits, the amount of data written in the buffer 19 by the DSP 18 is smaller than the remaining storage capacity of the buffer 19 at this time point. Therefore, the DSP 18 determines that the 16-bit data can be written in an address of eight of the buffer 19. After that, the DSP 18 makes access to the buffer 16, reads and decodes the music data, and writes the decoded music data in the address of eight of the buffer 19. In this case, the buffer 19 will store data of areas corresponding to 4+1=5. In this example, a total sum of the storage areas of the buffer 19 is ten. Therefore, the DSP 18 determines that the buffer 19 stores data of 5/10=50% of the storage capacity at this time point. Thus, the DSP 18 determines that the clock frequency of the clock signal supplied from the PLL circuit 13 is appropriate because the value of 50% is not larger than the predetermined reference value (50%), so the value of the clock frequency is not changed.

The DSP 18 makes access to the buffer 19 so as to perform the above-mentioned process for controlling the clock frequency every one second also after the time point t1. For example, if a sum of an amount of data stored in the buffer at a time point t2 and an amount of data to be written in the buffer 19 by the DSP 18 is 80% of the maximum amount of data that can be stored in the buffer 19 as a result of the above-mentioned process performed by the DSP 18 after making access to the buffer 19 at the time point t2, the DSP 18 determines that the clock frequency of the clock signal supplied from the PLL circuit 13 is high, so as to perform control for decreasing the clock frequency. For example, the DSP 18 performs control of decreasing the clock frequency from 120 MHz to 40 MHz.

In the same manner, if a sum of an amount of data stored in the buffer at a time point t3 and an amount of data to be written in the buffer 19 by the DSP 18 is 40% of the maximum amount of data that can be stored in the buffer 19 as a result of the above-mentioned process performed by the DSP 18 after making access to the buffer 19 at the time point t3, the DSP 18 determines that the clock frequency of the clock signal supplied from the PLL circuit 13 is low, so as to perform control for increasing the clock frequency. For example, the DSP 18 performs control of increasing the clock frequency from 40 MHz to 60 MHz.

When the above-mentioned process is performed repeatedly, the clock frequency supplied from the PLL circuit 13 to the DSP 18 converges to a constant value to be optimized. In the above-mentioned example, a value of the clock frequency is optimized so that the buffer 19 can keep an amount of music data corresponding to 50% of the maximum storage capacity at every time point when the DSP 18 makes access to the buffer 19. The value of the clock frequency to converge can be determined arbitrarily in accordance with the storage capacity of the buffer 19 and the music data to be stored in the buffer 19.

In the present embodiment, the DSP 18 performs control of the clock frequency so that the buffer 19 can keep a constant amount of data. Therefore, the outputting buffer 19 is not filled up with the decoded music data received from the DSP 18. Accordingly, in the present embodiment, there is not generated the period while the DSP 18 does not decode the music data because the DSP 18 cannot write the decoded data in the buffer 19. In other words, the DSP 18 does not continue to receive the clock signal and to consume wasteful power in the period. In addition, the embodiment of the present invention can prevent wasteful power consumption of the DSP 18 that happens in the conventional method of decreasing a clock frequency of the clock signal received by the DSP 18 during the period. In addition, it can flexibly support the case in which throughput of the DSP 18 necessary for the decoding process changes suddenly. If the throughput of the DSP 18 increases, an amount of data to be written in the buffer 19 after the DSP 18 makes access to the buffer 19 is decreased as long as the clock frequency does not change. Then, an amount of data stored in the buffer 19 is also decreased. Here, the DSP 18 regularly makes access to the buffer 19 for checking an amount of data stored in the buffer 19 so as to control the clock frequency of the clock signal supplied from the PLL circuit 13. In this case, the DSP 18 performs control of increasing the clock frequency of the clock signal supplied from the PLL circuit 13. Therefore, although the clock frequency of the clock signal supplied from the PLL circuit 13 increases temporarily, the clock frequency repeats to increase and decrease after that, and the clock frequency converges to an optimal value corresponding to the increased throughput of the DSP 18 after a predetermined time. Then, the amount of data stored in the buffer 19 converges to 50% of the maximum storage capacity. Further, in the present embodiment, the clock frequency of the clock signal supplied from the PLL circuit 13 is optimized by using the amount of music data stored in the buffer 19 as a parameter. Therefore, regardless of a compression format of data to be decoded by the DSP 18, the clock frequency of the clock signal supplied from the PLL circuit 13 to the DSP 18 can be optimized. More generally, the present embodiment enables optimization of the clock frequency of the clock signal supplied from the PLL circuit 13 to the DSP 18 regardless of an encode format of data to be decoded by the DSP 18.

In addition, the DSP 18 changes the frequency of the clock signal in accordance with an amount of data in the buffer. Therefore, if there is data to be decoded, the clock signal is constantly supplied to the DSP 18, although the frequency of the clock signal is changed. Thus, since the DSP 18 does not stop if there is data to be decoded, time from the stop to start of the decoding process can be neglected. In addition, since the processor operates always at an optimal frequency, power consumption of the processor can be controlled to a minimum level.

In the present embodiment, the processor that performs data processing is a digital signal processor, and the process performed by the digital signal processor is a decoding process of compressed music data. However, the processor may be a CPU, and the process performed by the processor is not limited to the decoding process of compressed data. The present invention can be applied to any data as long as it is data to be decoded, namely, it is encoded data. In addition, the present invention can be applied also to a case in which the CPU performs other operation and a result of the operation is written in a predetermined buffer. Further, the present invention can be applied not only to the case of music data compressed in a predetermined format but also to a case of moving picture data compressed in a predetermined format. It is apparent that the present invention is not limited to the above embodiments, but may be modified and changed without departing from the scope and spirit of the invention.

What is claimed is:

1. A data processing system comprising:
a clock control unit supplying a clock signal;
a processor coupled to said clock control unit to output write data in accordance with said clock signal, an amount of said write data being responsive to a frequency of said clock signal; and
a buffer coupled to said processor to receive said write data as a new entry of stored data therein and output a part of said stored data, said entry of said stored data increasing in response to said write data and decreasing in response to said part,
wherein said processor controls said frequency of said clock signal in response to an amount of said entry in said buffer.

2. The data processing system according to claim 1, wherein said processor decreases said frequency of said clock signal when said entry of said stored data is more than a predetermined value, and said processor increases said frequency of said clock signal when said entry of said stored data is less than said predetermined value.

3. The data processing system according to claim 1, further comprising:
a timer coupled to said processor to count a elapsed time, wherein said processor controls said frequency of said clock signal per a predetermined elapsed time.

4. The data processing system according to claim 1, wherein said processor is a digital signal processor decoding a compressed data in a predetermined format.

5. The data processing system according to claim 4, wherein said processor outputs said write data as a decoded result of said compressed data.

6. A combination comprising:
a circuit outputting a data; and
a buffer receiving said data to store said data;
wherein said circuit controls an amount of said data in response to a remaining capacity of said buffer.
